(19) United States
(12) Patent Application Publication
(10) Pub. No.: US 2019/0138696 A1
(43) Pub. Date: May 9, 2019

(54) SYSTEMS AND METHODS FOR SHARING HEALTH AND FITNESS STORIES

(71) Applicant: Under Armour, Inc., Baltimore, MD (US)

(72) Inventors: Kaitlyn Carpenter, Austin, TX (US); Daniel Townson, Austin, TX (US); John Dasta, Austin, TX (US)

(21) Appl. No.: 15/806,897

(22) Filed: Nov. 8, 2017

(51) Int. Cl. G06F 19/00

(52) U.S. Cl. CPC G06F 19/3481

(57) ABSTRACT

Systems and methods for sharing health and fitness stories are disclosed. In one embodiment, a fitness tracking system comprises a remote server and one or more electronic display devices and/or activity monitoring devices. In one embodiment, a method comprises tracking a plurality of performance metrics of a user for the duration of a workout, at least some of the plurality of performance metrics based on positions of the user during the workout. The method further comprises associating individual ones of a plurality of media items with a particular time and/or position of the user during the workout. The method further comprises displaying a summary of the workout on a display device, the summary including each of the plurality of media items displayed in association with its respective time and/or position.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

The device and method disclosed in fitness tracking systems and, more particularly, to sharing health and fitness stories using a fitness tracking system.

### BACKGROUND

Activity tracking devices are increasingly utilized by individuals interested in tracking metrics related to their personal health and fitness activity. These activity tracking devices include, for example, heart rate monitors, step counters, stair counters, global positioning system (“GPS”) tracking devices, as well as various other motion and biometric tracking devices. Some activity tracking devices include features for tracking workouts and sharing fitness data (or so called “stats”) regarding individual workouts with other users. However, shared fitness data is often ignored by the other users because the data is not presented in an engaging or interesting manner. In view of the foregoing, it would be advantageous to provide a method of sharing health and fitness stories with greater customization and interactivity to improve users' engagement with their activity tracking devices and to improve health and fitness outcomes.

### SUMMARY

In accordance with one exemplary embodiment of the disclosures, a method of operating a health tracking system is disclosed. The method comprises tracking a plurality of performance metrics of a user for a duration of a workout of the user using at least one sensor of the health tracking system, at least some of the plurality of performance metrics based on positions of the user during the workout, the positions of the user during the workout being sensed using a position sensor of the health tracking system; associating individual ones of a plurality of media items with at least one of (i) a particular time during the workout, and (ii) a particular position of the user during the workout; and displaying a summary of the workout on a display device of the health tracking system, the summary including the individual ones of the plurality of media items displayed in association with its respective at least one of (i) the particular time during the workout, and (ii) the particular position of the user during the workout.

In accordance with another exemplary embodiment of the disclosures, a further method of operating a health tracking system is disclosed. The method comprises receiving workout data at a display device of a first user of the health tracking system from a remote server of the health tracking system, the workout data including a plurality of performance metrics of a second user for a duration of a workout of the second user and a plurality of media items associated with the workout, at least some of the plurality of performance metrics based on positions of the second user during the workout, each media item in the plurality of media items being associated with (i) a particular time during the workout and (ii) a particular position of the second user during the workout; and displaying a timeline of the workout on the display device of the first user, wherein visual representations of the media items in the plurality of media items are overlaid on the timeline at the respective times during the workout with which the respective media items are associated.

In accordance with yet another exemplary embodiment of the disclosures, a health tracking system is disclosed. The health tracking system comprises a first mobile display device having at least a camera and a position sensor. The first mobile display device is configured to capture a plurality of media items using the camera; track a plurality of performance metrics of a first user for a duration of a workout of the first user, at least some of the plurality of performance metrics based on positions of the first user during the workout, the positions of the user sensed using the position sensor; and associate individual ones of the plurality of media items with at least one of (i) a particular time during the workout and (ii) a particular position of the first user during the workout.

### BRIEF DESCRIPTION OF THE DRAWINGS

The foregoing aspects and other features of a fitness tracking system are explained in the following description, taken in connection with the accompanying drawings.

FIG. 1 is a diagrammatic view showing an exemplary embodiment of a fitness tracking system including an activity monitoring device and an electronic display device.

FIG. 2 is a block diagram of exemplary electronic components in the activity monitoring device and the electronic display device of the fitness tracking system of FIG. 1.

FIG. 3 is a plan view showing the electronic display device of the fitness tracking system of FIG. 1 displaying an activity tracking screen that enables a user to track performance metrics during a workout.

FIG. 4 is a plan view showing the electronic display device of the fitness tracking system of FIG. 1 displaying a real-time tracking screen that enables real-time viewing of certain performance metrics during the workout.

FIG. 5 is a logical flow diagram for a method of sharing workout data in a fitness tracking system.

FIG. 6 is a plan view showing the electronic display device of the fitness tracking system of FIG. 1 displaying a workout sharing screen that enables the user to select individual ones of a plurality of media items to be shared with the workout.

FIG. 7 is a plan view showing the electronic display device of the fitness tracking system of FIG. 1 displaying a highlight photo screen that enables a user to select individual ones of a plurality of performance metrics to be overlaid on the highlight photo for the workout.

FIG. 8 is a logical flow diagram for a method of presenting workout data to a user of a fitness tracking system.

FIG. 9 is a plan view showing the electronic display device of the fitness tracking system of FIG. 1 displaying an activity feed screen that enables users to view contents, including workout summaries, shared by friends and other members of the community.

FIG. 10 is a plan view showing the electronic display device of the fitness tracking system of FIG. 1 displaying a workout summary screen that enables users to view a detailed summary of a user's workout.

FIG. 11 is a plan view showing the electronic display device of the fitness tracking system of FIG. 1 displaying a media item screen that enables users to view a media item that was shared with a workout.

All Figures ©Under Armour, Inc. 2017. All rights reserved.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

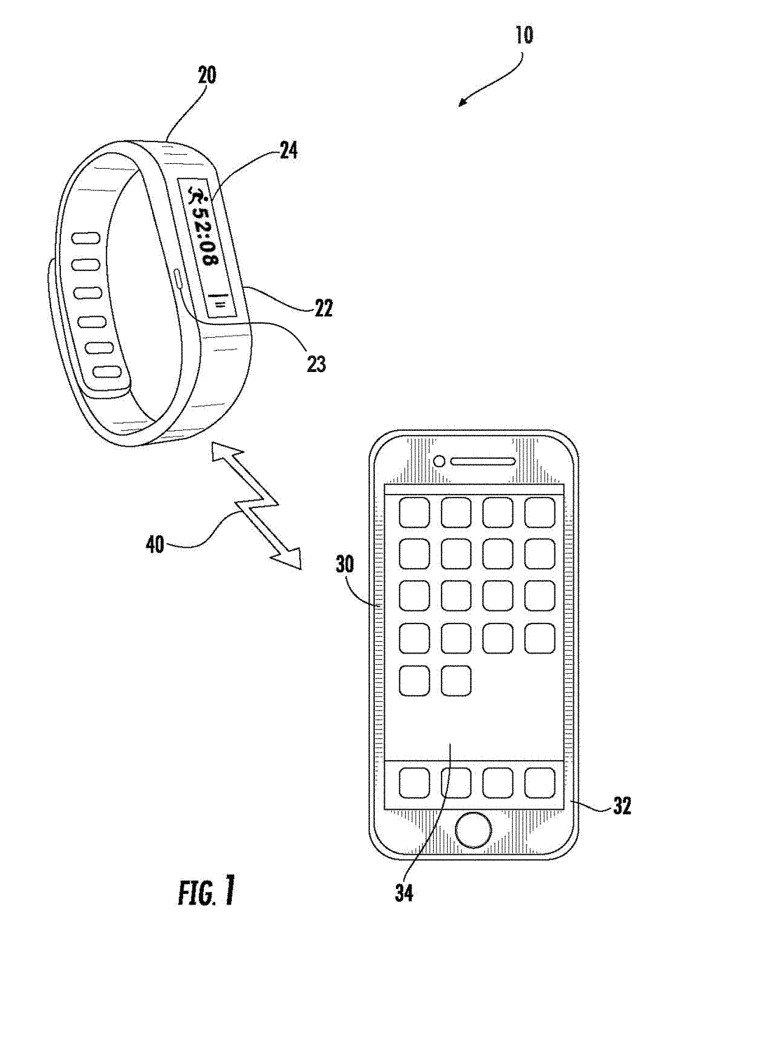

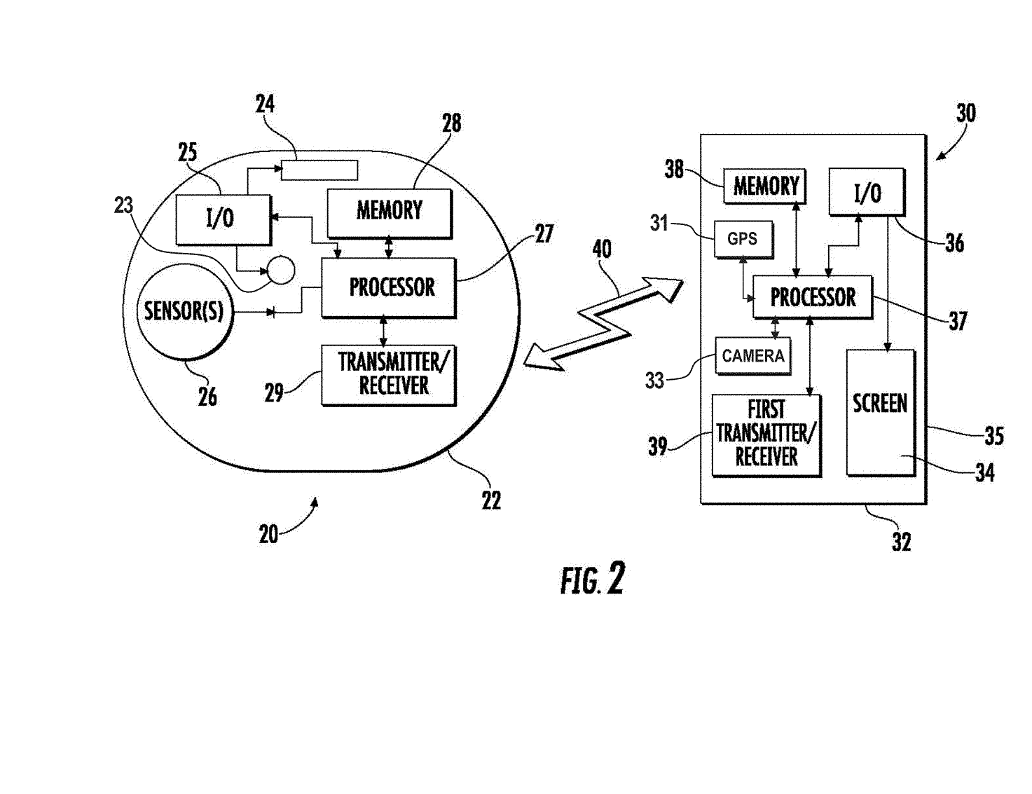

With reference to FIGS. 1-2, an exemplary embodiment of a fitness tracking system 10 for recording fitness data during an activity or workout (which may also be referred to herein as the “health tracking system” or the “activity tracking system”). In one embodiment, the fitness tracking system 10 includes at least one activity monitoring device 20 and at least one electronic display device 30 in communication therewith. The activity monitoring device 20 is a user device configured to measure one or more health and fitness parameters of a user during an activity or workout and provide fitness data regarding the activity or workout to the electronic display device 30. In many embodiments, the activity monitoring device 20 is designed and dimensioned to be worn on or carried by the body of a user. However, the activity monitoring device 20 may also be a designed and dimensioned to be attached to or integrated with certain mobile fitness equipment, such as bicycles, roller blades, skateboards, scooters, or the like. In some embodiments, the fitness tracking system 10 includes more than one activity monitoring device 20 associated with the individual user. The electronic display device 30 is a user device designed to process the fitness data and display it to the user in a format that summarize a user's performance during an activity or workout. In some embodiments, the electronic display device 30 may also collect fitness data independently of any dedicated activity monitoring devices 20 and, in this way, may function as the activity monitoring device 20 or as one of the activity monitoring devices 20.

The term “fitness data” as used herein refers to data relating to a user's fitness and performance during an activity or workout, but also data regarding the user's health and general well-being outside of the activity or workout, and may also be referred to herein as “fitness information” or “fitness parameters.” Fitness data may include activity data, physiological data, and performance perception data. Fitness data may be in a raw measured form or in a processed form. Fitness data may be automatically measured, sensed, or collected by the activity monitoring device 20 and/or the electronic display device 30, but may also be entered manually by the user via the activity monitoring device 20 and/or the electronic display device 30. The term “activity data” as used herein is a subset of fitness data, and refers to data related to physical activity (i.e., movement or lack thereof) of the user. Examples of activity data include body motion/acceleration data, step data, stride length data, distance traversal data, pace/speed data, altitude data, environmental/positional data (such that provided by a GPS receiver), exercise weight/resistance data, exercise repetition data, and/or any of various other types of personal activity metrics that may be relevant the user's physical activity for a given period of time. The term “physiological data” as used herein is a subset of fitness data, and refers to data related to the physiological status and health of the user. Examples of physiological data include age, gender, height, body weight, body fat, heart rate, aspiration rate, blood oxygenation, blood glucose, hydration, caloric expenditure, or any of various other types of physiological metrics that may be relevant the user's physiological health for a given period of time. The term “performance perception data” as used herein is a subset of fitness data, and refers to data related a personal feeling or subjective perception of one's own performance or physical-fitness as determined by the user himself or herself based on the user's own senses, feelings, awareness, mental impressions, and/or other perceptions of the user. Performance perception data may broadly relate the user's perception of his or her overall performance generally or his or her overall performance during a particular activity or workout, but may also relate to the user's perception of particular aspects of his or her performance, such as the user's perception of his or her time, pace, distance, calories burned, and/or any of the fitness parameters discussed above.

While the activity monitoring device 20 is described herein as the primary device for collecting and transmitting fitness data to the electronic display device 30, it will be recognized that additional data may also be collected or otherwise obtained and/or input in to the electronic display device 30 via various other mechanisms. In at least one embodiment, the user may manually input data directly into the activity monitoring device 20 and/or the electronic display device 30. For example, the user may manually collect exercise weight/resistance data or exercise repetition data and input such data into the activity monitoring device 20 and/or the electronic display device 30 without the use of a sensor and/or other device for transmitting the fitness data to the electronic display device 30.

In the instance in which a user utilizes one or more activity monitoring devices 20, fitness data from each device 20 is delivered to the electronic display device 30. As represented by the arrow 40 in FIGS. 1 and 2, the one or more activity monitoring devices 20 are configured to transmit a wireless RF signal representative of the fitness data collected or obtained thereat to at least one display device 30. In addition, the fitness data may also be transmitted to additional computing devices, such as a watch, personal computer, and/or a laptop computer where the fitness data may be conveniently displayed for the user. In other embodiments, a wired connection may be utilized for communication of fitness data between the electronic display device 30 and the activity monitoring device 20. Similarly, in another embodiment, the fitness data may be transmitted from the activity monitoring devices 20 and/or the display device 30 to the aforementioned network server (not shown). The data may then be accessed by the user at any number of additional computerized devices via a username and password, or other form of identification and authentication of the user.

Although not illustrated, in one embodiment, the activity monitoring device 20 and electronic display device 30 may communicate via a network to a network-side database and/or remote server (not shown) for storage and/or processing of the fitness data, thereby decreasing the processing capacity required at either user device (e.g., the activity monitoring device 20 or electronic display device 30).

In at least one embodiment, the transmission of data from the activity monitoring device 20 to the electronic display device 30 (or to the network server (not shown)) occurs automatically without requiring the user to prompt or initiate the transmission. In another embodiment, the activity monitoring device 20 may be configured to begin transmissions once it receives a confirmation that the electronic display device 30 is within an appropriate range of the activity monitoring device 20. In yet another embodiment, data transmission may occur periodically at predetermined intervals of time. In other embodiments, where communications between the activity monitoring device 20 and the electronic display device 30 are made with a wired connection, communications only occur when the wired connection is established between the activity monitoring device 20 and the electronic display device 30. Similar logic applies to the transmission of data from the activity monitoring device 20 and/or the electronic display device 30 to the network server (not shown).

In the embodiment disclosed herein, the activity monitoring device 20 is shown as being a completely separate unit from the electronic display device 30. However, in at least one embodiment, the activity monitoring device 20 and the electronic display device 30 are provided as a single unit. For example, the activity monitoring device 20 and the electronic display device 30 may be provided as part of a mobile phone, so-called “smart” watch or other personal electronic device. In such embodiments, duplicative hardware described below can be combined and/or eliminated. Additionally, while a single activity monitoring device 20 is shown in the embodiment of FIG, 1, it will be recognized that multiple activity monitoring devices 20 may be used by a single user, each of the activity monitoring device 20 configured for communication with the electronic display device 30. An exemplary activity monitoring device 20 and an exemplary electronic display device 30 will be discussed in further detail below.

Activity Monitoring Device

With continued reference to FIGS. 1-2, the activity monitoring device 20 (which may also be referred to herein as a “activity tracking device”, or a “sensor device”) may be provided in any of various forms and is configured to measure, collect and/or otherwise obtain any of the various types of fitness data (as discussed above). The fitness data during an activity or workout may be collected automatically by a sensor of the activity monitoring device 20, via manual entry by the user, and/or collected by any of various other means. In at least one embodiment, the activity monitoring device 20 is an activity tracker configured to measure one or more of steps taken (including walking or running), distance traversed, stairs climbed, heart rate, as well as various other types of activity data or physiological data (such “activity trackers” are commonly also referred to as “fitness trackers”).

In one exemplary embodiment the activity monitoring device 20 is configured to be worn or carried by the human user. For example, in the embodiment shown in FIG. 1, the activity monitoring device 20 is provided as a wrist band that the user straps to his or her wrist. However, it will be recognized that in other embodiments, the activity monitoring device 20 may be provided in any of various different configurations to be worn on any of various locations on the body of the user, such as via a module that clips on to clothing, is worn on a chest strap, fits in a pocket of the user, and/or is incorporated into a garment or a shoe. Alternatively, the activity monitoring device 20 may be configured so as to be fixed to or integrated with mobile fitness equipment, such as in the case of a bicycle speed, power, and/or cadence sensor device. Additional examples of configurations for the activity monitoring device 20 include configurations where the sensor device is provided as a component of a multi-function device, such as a watch, a mobile phone or other personal electronic device. Additional or alternative examples of activity monitoring devices 20 include those sold under the trademarks FITBIT®, JAWBONE®, POLAR®, SAMSUNG®, APPLE® and UNDER ARMOUR®.

With continued reference to the embodiment of FIGS. 1 and 2, the activity monitoring device 20 includes a protective outer shell or housing 22 designed to retain and protect various sensors and other electronic components positioned within the housing 22. The housing 22 comprise any number of shapes, configurations, and/or materials, the description herein being merely exemplary. In at least one embodiment, the housing 22 includes a relatively rigid portion that securely retains the electronic components, and a more resilient portion which functions as an outer layer to provide shock absorption features in the event the activity monitoring device 20 is dropped, falls, or otherwise withstands an amount of force. The activity monitoring device 20 and housing 22 may be configured to be worn or otherwise carried by the user in any of a number of ways. For example, the housing 22 of the activity monitoring device 20 may be provided as part of a chest or wrist strap having an associated clasp, or may include a clip or other arrangement that allows the activity monitoring device 20 to be coupled to the clothing of the user (as discussed elsewhere herein). In other embodiments, the housing 22 is configured to attach the activity monitoring device 20 to a body of a bicycle or other mobile fitness equipment.

The activity monitoring device 20 may also include other features visible on the housing 22 such a button 23, a display 24, one or more connection ports (not shown), or other input/output hardware and software that operate in conjunction with an I/O interface 25. In the embodiment shown, the button 23 comprises a tactile button, switch, and/or toggle. However, in other embodiments, the button 23 may also comprise capacitive or resistive touch sensor. The display 24 may vary based on the type of device. For example, in the embodiment shown, the display 24 comprises an LCD or LED screen that provides performance metric information (e.g., time, distance, pace, heart rate, progress toward a goal, or some combination thereof, etc.), notifications, text messages, caller ID, etc. to the user. In some embodiments, the display 24 is a touch screen display that allows the user to provide inputs to the I/O interface 25 via virtual buttons or other interfaces on the touch screen. Alternatively, in one embodiment, the display 24 may simply be one or more colored lights and/or flashing patterns configured to communicate information to the user (e.g., progress towards a goal or other performance metric). The connection ports may be used to connect the activity monitoring device 20 to a power source or to share data with other electronic devices.

As shown in FIG. 2, the activity monitoring device 20 includes electronic circuitry comprising, the I/O interface 25, one or more sensors 26 (optional), a processor 27, a memory 28, and the transmitter/receiver 29. The activity monitoring device 20 also includes a battery or other power source (not shown) configured to power the various electronic devices within the activity monitoring device 20. In at least one embodiment, the battery of the activity monitoring device 20 is a rechargeable battery. In this embodiment, the activity monitoring device 20 may be placed in or connected to a battery charger configured for use with the activity monitoring device 20 in order to recharge the battery.

In one embodiment, the activity monitoring device 20 comprises one or more sensors 26. The sensors 26 may comprise any of various devices configured to collect the activity or physiological data, including step data, motion data, distance traversal data, pace data, GPS data, altitude data, heart rate data, breathing data, environmental/positional data, and/or any of various other types of fitness data that may be relevant to determining activities of the wearer. In at least one embodiment, the sensors 26 include a 3-axis accelerometer configured to detect the motions of the wearer during walking, running, bicycling, swimming, or the like. Of course, it will be recognized by those of ordinary skill in the art that numerous other sensors may be used, depending on the type of activity the activity monitoring device 20 is designed to detect.

With continued reference to FIG. 2, the processor 27 may be any of various microprocessors as will be recognized by those of ordinary skill in the art. The processor 27 is configured to receive data signals from the sensors 26, and other component parts of the activity monitoring device 20 (such as data entered via the I/O interface 25), and process such signals. The processor 27 is connected to the memory 28 and the transmitter/receiver 29, and may deliver processed data to one or both of the memory 28 and the transmitter/receiver 29. Additionally, the processor 27 may perform some processing on the received data prior to delivery thereof to the memory 28 or transmitter/receiver 29. For example, the processor 27 may associate the fitness data with a particular time, day, user (in the instance that the device is configured to collect data relating to more than one user), and/or event. The processor 27 is also connected to the I/O interface 25, and may send signals to the I/O interface 25 which results in illumination of the display 24 in order to provide text and/or image based messages or otherwise communicate to the user.

The memory 28 is configured to store information, including both data and instructions. The data may be retrieved from the processor 27 and generally includes fitness data, but may also include various types of operational data that may be ancillary to the basic operation of the activity monitoring device 20. The instructions which are stored at the memory 28 generally include firmware and/or software for execution by the processor 27, such as a program that controls the settings for the sensor device, a program that controls the output of the display 24 on the activity monitoring device 20, a program that controls the receipt of information via the sensor 26, a program that controls the transmission and reception of data via the transmitter/receiver 29, as well as any of various other programs that may be associated with the activity monitoring device 20. Such instructions may be present on the device 20 at the time of manufacture or may be downloaded thereto via well-known mechanisms. The memory 28 may be of any type capable of storing information accessible by the processor 27, such as a memory card, ROM, RAM, write-capable, read-only memories, or other computer-readable medium. The data may be stored in the memory 28 in a relational database as a table having a plurality of different fields and records, XML documents, or flat files. The data may also be formatted in any computer-readable format such as, but not limited to, binary values, ASCII or Unicode.

The transmitter/receiver 29 in one embodiment comprises an RF transmitter and receiver configured to transmit and receive communications signals over a short range using a wireless communications technology, such as Wi-Fi or Bluetooth®, using any of various communications protocols, such as TCP/IP. Such transmitter/receivers are well known and will be recognized by those of ordinary skill in the art. The transmitter/receiver 29 is particularly configured to communicate with the electronic display device 30 when the activity monitoring device 20 is within a given range of the electronic display device 30, and transmit collected fitness data to the electronic display device 30.

Electronic Display Device

With continued reference to FIGS. 1-2, the electronic display device 30 (also referred to herein as a “display device” or a “user device”) generally includes an input/output interface 36, a processor 37, a memory 38, and a transmitter/receiver 39. Additionally, the electronic display device 30 also includes a battery or other power source (not shown) configured to power the electronic components within the electronic display device 30. In at least one embodiment, the electronic display device 30 is a handheld mobile computing device, such as a smartphone. While a smartphone has been shown as the electronic display device 30 in FIGS. 1 and 2, it will be appreciated that the electronic display device 30 may alternatively comprise any number of devices. For example, the electronic display device 30 may be a standalone device, such as a desktop PC, and/or smart television. Alternatively, the electronic display device 30 may be any type of portable or other personal electronic device such as a watch, tablet computer, laptop computer, and/or any of various other mobile computing devices. As will be recognized by those of ordinary skill in the art, the components of the electronic display device 30 may vary depending on the type of display device used. Such alternative display devices may include much (but not necessarily all) of the same functionality and components as the electronic display device 30 shown in FIGS. 1 and 2, as well as additional functionality or components necessary for proper functioning thereof (not shown).

The I/O interface 36 of the electronic display device 30 includes software and hardware configured to facilitate communications with the one or more activity monitoring devices 20 and/or communications to the user him/herself. The hardware includes a display screen 34 configured to visually display graphics, text, and other data to the user. The hardware may also include a microphone and/or speakers to facilitate audio communications with the user and/or verbal entry of commands to the device 30. In at least one embodiment, the display screen 34 is a touch screen display that allows the user to see data presented on the display screen 34 and input data into the electronic display device 30 via a virtual keyboard or other interface on the touch screen. However, other means for receiving user input, such as a physical keyboard, may also be provided with equal success.

The processor 37 of the electronic display device 30 may be any of various processors as will be recognized by those of ordinary skill in the art. The processor 37 is connected to the I/O interface 36, the memory 38, and the transmitter/receiver 39, and is configured to deliver data to and/or receive data from each of these components. It will be recognized by those of ordinary skill in the art that a “processor” as used herein includes any hardware system, hardware mechanism or hardware component that processes data, signals, and/or other information. A processor can include a system with a central processing unit, multiple processing units, dedicated circuitry for achieving functionality, and/or other systems.

The memory 38 is configured to store information, including both data and instructions. The data may be, for example, fitness data as discussed above, which may be related to the activities, workouts, health and fitness profile, etc. of the user, along with other operational data that may be ancillary to the basic operation of the electronic display device 30 and any applications retained on the electronic display device 30. The instructions which are stored at the memory 38 generally include firmware, an operating system, and/or other software for execution by the processor 37, such as one or more programs that control the settings for the electronic display device, one or more programs that control the output of the display 34 on the electronic display device 30, one or more programs that control various applications on the electronic display device 30, one or more programs that control the transmission and reception of data via the transmitter/receiver 39, as well as any of various other programs that may be associated with the electronic display device 30. In at least one embodiment, the instructions stored in the memory 38 include activity or workout tracking application, discussed in greater detail below, which is executed by the processor 37 to process fitness data and present the fitness data in a graphical format on the display screen 34. The memory 38 may be of any type of device capable of storing information accessible by the processor, such as a memory card, ROM, RAM, write-capable memories, read-only memories, hard drives, discs, flash memory, or any of various other computer-readable medium serving as data storage devices, as will be recognized by those of ordinary skill in the art.

The transmitter/receiver 39 is, in one embodiment, an RF transmitter and receiver configured to transmit and receive communications signals using a wireless communications technology, such as Wi-Fi or Bluetooth®, using any of various communications protocols, such as TCP/IP. Such transmitter/receivers are well known and will be recognized by those of ordinary skill in the art. The transmitter/receiver 39 is particularly configured to communicate with a transmitter/receiver 29 of the activity monitoring device 20. In at least one embodiment, the transmitter/receiver 39 is configured to allow the electronic display device 30 to communicate with a wireless telephony network, as will be recognized by those of ordinary skill in the art. The wireless telephony network may comprise any of several known or future network types. For example, the wireless telephony network may comprise commonly used cellular phone networks using CDMA or FDMA communications schemes. Some other examples of currently known wireless telephony networks include Wi-Fi, WiMax, GSM networks, as well as various other current or future wireless telecommunications arrangements.

As discussed above, in at least some embodiments, the electronic display device 30 also functions as one of the activity monitoring device 20 and collects certain fitness data independent dedicated activity monitoring devices 20. Particularly, in at least one embodiment, the electronic display device 30 includes a GPS receiver 31 configured to record a global position of the user during an activity or workout. Additionally, in some embodiments, the electronic display device 30 also includes sensors, such as a 3-axis accelerometer, altimeter, etc. (not shown), configured to record fitness data during an activity or workout.

In at least one embodiment, the electronic display device 30 includes a camera 33 having at least one photo-sensitive element configured to capture an image and/or video of the surroundings. The processor 37 is configured to operate the camera 33 to capture the image and/or video, to receive the image and/or video from the camera 33, and to store the image and/or video in the memory 38. A user may initiate capture of the image and/or video by pressing virtual buttons (not shown) on the display screen 34 or by pressing physical buttons (not shown) of the electronic display device 30.

The electronic display device 30 generally includes a protective outer shell or housing 32 designed to retain and protect the electronic components positioned within the housing 32. The housing 32 may comprise any number of shapes, configurations, and/or materials, the description herein being merely exemplary. In at least one embodiment, the housing 32 includes a relatively rigid portion that securely retains the electronic components, and a more resilient portion which functions as an outer layer to provide shock absorption features in the event the device 30 is dropped, falls, or otherwise withstands an amount of force. In embodiments wherein the electronic display device 30 also functions as one of the activity monitoring devices 20, the housing 32 may serve as a common housing for components of the electronic display device 30 and components of the activity monitoring device 20.

In at least one embodiment, the instructions stored in the memory 38 of the electronic display device 30 includes an activity tracking application (which may also be referred to herein as the “workout tracking application”), which is executed by the processor 37 to provide a graphical user interface that enables the user to track, view, and manage his or her fitness data. An exemplary activity tracking application will be discussed in further detail below.

Activity Tracking Application

The activity tracking application, stored in the memory 38 of the electronic display device 30, at least includes instructions for enabling a user to track a plurality of performance metrics during an activity or workout. Particularly, the activity tracking application includes instructions for collecting and processing fitness data during an activity or workout to provide various performance metrics to the user. The term “performance metric” as used herein refers to any standard of measurement relevant to an assessment of the performance, fitness, and health of the user during an activity or workout, or series of activities or workouts. In some cases, the raw measured fitness data is processed substantially to provide a performance metric, but in other cases, measured fitness data may simply be organized into a more presentable form to provide the performance metric. Performance metrics can be generally be considered a further type of fitness data, as defined above. Some examples of performance metrics include heart rate sensor data expressed as beats per minute during an activity or workout, acceleration data expressed a total number of steps during an activity or workout, GPS data expressed as a total distance traversed during an activity or workout, GPS data expressed as positions over time and/or a route/path of the user during an activity or workout, GPS data expressed as an speed/pace over time or average speed/pace during an activity or workout, GPS data or altimeter data expressed as an elevation over time during an activity or workout, fitness data expressed as an estimated number of calories burned, time data expressed a total amount of time spent during an activity or workout, and fitness data express as a total number of workouts or number of workouts during a particular time period (e.g., workouts per week). Further exemplary performance metrics may include any parameter of fitness data expressed as an average over a particular duration of time (e.g. the duration of the workout), as a data plot over the particular duration of time, as a maximum or minimum over the particular duration of time, as a value for some point in time of particular interest, or as a percentage of a user's health or fitness goal or other standard.

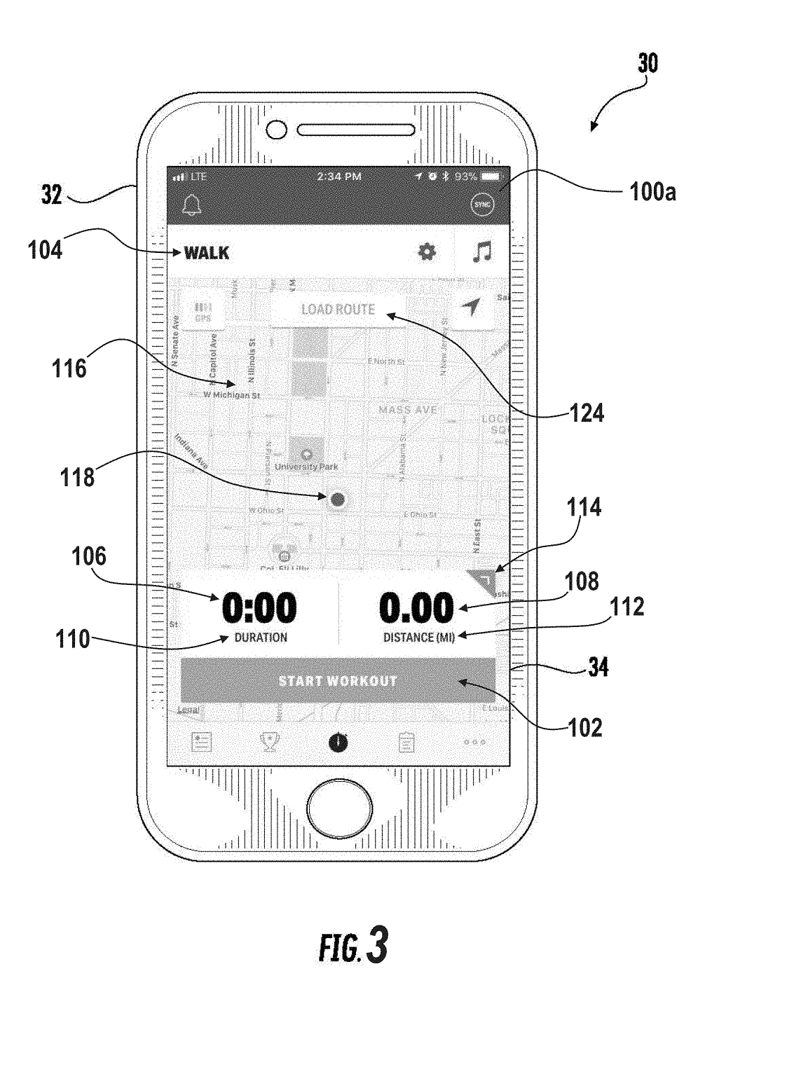

FIG. 3 shows an exemplary embodiment of an activity tracking screen 100a that is displayed on the display screen 34 of the electronic display device 30 to enable a user to track a plurality of performance metrics during an activity or workout. The processor 37 executes instructions of the activity tracking application stored in the memory 38 to display the activity tracking screen 100a on the display screen 34. The activity tracking screen 100a at least includes a start option 102 (e.g., “Start Workout”) that enables the user of the electronic display device 30 to initiate collection of fitness data during an activity or workout. Particularly, in response to the user pressing the start option 102, the processor 37 is configured to initiate collection of fitness data by any sensors of the electronic display device 30, such as the GPS receiver 31 and/or initiate reception of fitness data from the activity monitoring devices 20. In some embodiments, the activity tracking screen 100a includes workout settings option 104 that, when pressed, causes the processor 37 to display an additional menu on the display screen 34 via which the user can choose a type of workout (e.g., walk, run, road cycling, mountain bike, etc.), as well as choose other settings for the workout (e.g., coaching, voice feedback, delay start timer, gear tracking, and other workout settings).

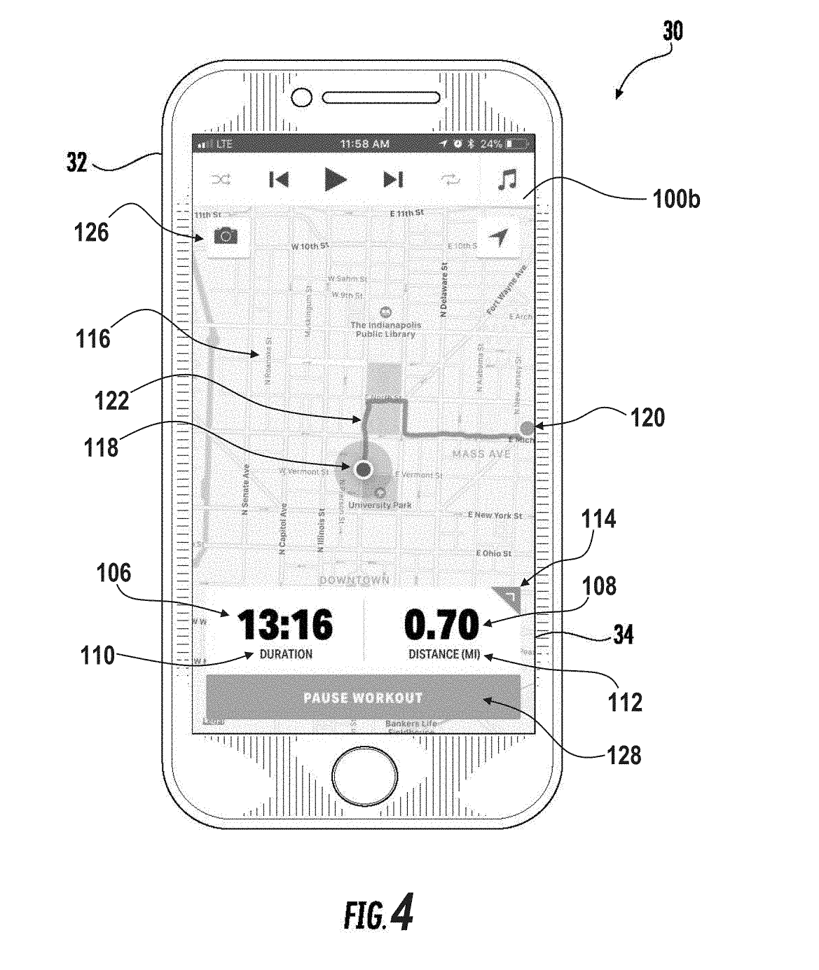

FIG. 4 shows an exemplary embodiment of a real-time tracking screen 100b that is displayed on the display screen 34 of the electronic display device 30 to enable to real-time viewing of certain performance metrics during the activity or workout. Particularly, in at least one embodiment, in response to the user pressing the start option 102 of the activity tracking screen 100a, the processor 37 executes instructions of the activity tracking application to display the real-time tracking screen 100b on the display screen 34, which is different from the activity tracking screen 100a. The real-time tracking screen 100b includes at least one performance metric that is displayed in real time during the activity or workout. Particularly, in the embodiment shown, the real-time tracking screen 100b includes performance metric values 106 and 108 and corresponding performance metric labels 110 and 112 which indicate which performance metrics are displayed (e.g., a “13:16” value for the “DURATION” performance metric and a “0.70” value for the “DISTANCE (MI)” performance metric). In one embodiment, the real-time tracking screen 100b further includes a expand button 114 that, when pressed by the user, causes the processor 37 to display an expanded view on the display screen 34 that shows values for additional performance metrics in real time during the activity or workout. Additionally, as shown in FIG. 3, the activity tracking screen 100a may also show the values 106 and 108, the labels 110 and 112, and the expand option 114.

Returning to FIG. 4, the real-time tracking screen 100b includes a map 116 of a geographical area surrounding the electronic display device 30. The processor 37 is configured to receive global position data from a GPS receiver of the electronic display device 30 or of an activity monitoring device 20 and overlay onto the map 116 in real time a current location 118, a starting location 120, and a route 122 for the current activity or workout. Additionally, as shown in FIG. 3, the activity tracking screen 100a may also show the map 116 and the current location 118. In some embodiments, the activity tracking screen 100a also includes a route option 124 that, when pressed, causes the processor 37 to display an additional menu on the display screen 34 via which the user can select a route for a previous workout. In response to a selection of the previous route, the processor 37 is configured to overlay the previous route (not shown) onto the map 116 of the real-time tracking screen 100b and/or the activity tracking screen 100a.

Returning to FIG. 4, the real-time tracking screen 100b further includes camera option 126 which enables the user to take a photograph or video during the activity or workout. Particularly, in response to a user pressing the camera option 126, the processor 37 is configured to cause the display screen 34 to display a camera mode screen (not shown) via which the user can capture an image or video using the camera 33 of the electronic display device 30. The processor 37 is configured to receive the captured image or video from the camera 33 and store it in the memory 38.

Finally, the real-time tracking screen 100b includes a pause/end option 128 which enables the user to pause and end tracking of the plurality of performance metrics during the activity or workout. In one embodiment, in response to the user pressing the pause/end option 128, the processor 37 stops collecting fitness data and displays a menu (not shown) on the display screen 34 from which the user can either resume the tracking the workout or end the workout. In at least one embodiment, once the user has ended the workout, the processor 37 is configured to perform additional processing of the collected fitness data to provide additional performance metrics to the user.

In some embodiments, the particular performance metrics that are provided for an activity or workout may depend on a subscription level the user maintains with the administrator of the fitness tracking system 10. Particularly, if the user has a standard subscription with the administrator of the fitness tracking system 10, only limited processing may occur, such as an average heart rate for a period of time or a total number of steps for a day. However, if the user has a higher subscription level with the administrator of the fitness tracking system, the processing of heart rate data may further include an analysis of the time the user spent in different heart rate zones during a given period of time, such as times in the fat burning zone, the aerobic zone, and the anaerobic zone. With respect to step data, users with a higher subscription level than other users may receive access to detailed information about cadence, split times, or other in-depth analysis performed by the processor 37 (which is not available to users with standard subscription levels).

Methods for Sharing and Presenting Workout Data

Methods for operating the fitness tracking system 10 are described below. In particular, methods of operating an electronic display device 30 and/or activity monitor devices 20 to share and present workout data are provided. In the description of the methods, statements that a method is performing some task or function refers to a controller or general purpose processor executing programmed instructions stored in non-transitory computer readable storage media operatively connected to the controller or processor to manipulate data or to operate one or more components in the fitness tracking system 10 to perform the task or function. Particularly, the processor 37 of the display device 30 and/or the processor 27 of the activity monitoring device 20 above may be such a controller or processor. Alternatively, the controller or processor may be implemented with more than one processor and associated circuitry and components, each of which is configured to form one or more tasks or functions described herein. Additionally, the steps of the methods may be performed in any feasible chronological order, regardless of the order shown in the figures or the order in which the steps are described.

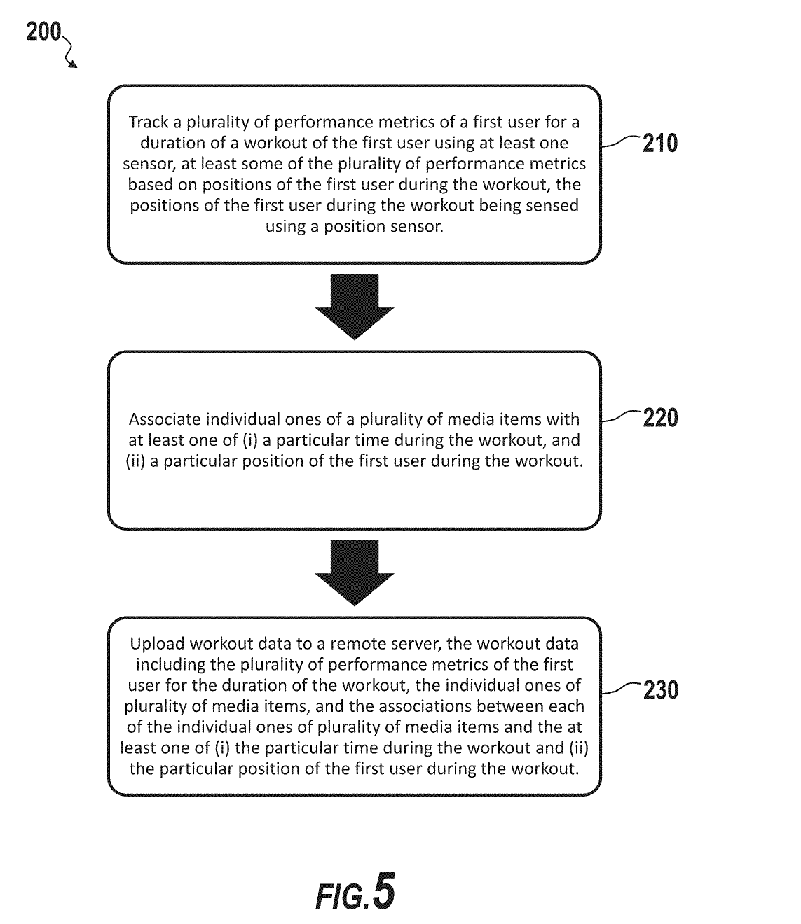

FIG. 5 shows a logical flow diagram for a method 200 of sharing workout data in a fitness tracking system. The method 200 begins with a step of tracking a plurality of performance metrics of a first user for a duration of a workout of the first user using at least one sensor (block 210). At least some of the plurality of performance metrics are based on positions of the first user during the workout and the positions of the first user during the workout are sensed using a position sensor (block 210). Particularly, with respect to the embodiments described in detail herein, in response to an input from a user, the processor 37 is configured to initiate collection of fitness data by any sensors of the electronic display device 30, including the GPS receiver 31 and initiate reception of fitness data from the activity monitoring devices 20. As discussed in more detail above, in some embodiments, the processor 37 is configured to, while collecting fitness data, calculate certain performance metrics in real time and display them on the display screen 34 (e.g. duration and distance, as shown in FIG. 3 and FIG. 4 above). Additionally, in some embodiments, once the user has ended the collection of fitness data for the particular workout, the processor 37 is configured to calculate additional performance metrics for the user's workout, such as the various types of performance metrics discussed above.

The processor 37 is configured to calculate at least some of the performance metrics based on position data, such as global position data received from the GPS receiver 31 of the electronic display device or from a GPS receiver of an activity monitoring device 20. Particularly, in one embodiment, the processor 37 is configured to calculate distance, duration, average pace, number of calories expended, and the route for the tracked activity or workout. In some embodiments, the processor 37 is configured to calculate an average heart rate during the workout and a plurality of heart rate values plotted over time for the duration of the workout, based on heart rate data received from a heart rate sensor. In some embodiments, the processor 37 is configured to calculate a plurality of elevation values plotted over time for the duration of the workout, based on altimeter data received from an altimeter. In some embodiments, rather than using global position data from a GPS receiver, the processor 37 is configured to determine or estimate position data based on from data received from a pedometer or accelerometer, or from data received from a cellular tower or nearby wireless access points/routers.

In one embodiment, the processor 37 is configured to determine whether various milestones or achievements where completed during the duration of the workout. Particularly, the processor 37 is configured to compare one or more values for at least one performance metric in the plurality of performance metrics with a predetermined performance criterion for the at least one performance metric. As used herein, the term “performance criterion” refers to a goal, milestone, or benchmark with respect a performance metric. Some examples of performance criterion include a goal for cumulative distance traveled during all workouts or all workouts of a particular type (e.g., 100 cumulative miles ran, 1000 cumulative miles biked), a goal for time for a particular distance (e.g., run 5 kilometers in under 30 minutes), a goal for a percentage of time spent in a particular heart rate zone during a workout (e.g., spend at least 50% of workout in the aerobic or anaerobic heart zones), a goal for a cumulative number of workouts tracked in a week (e.g., track at least three workouts in a week), and a goal for positive change in elevation during a workout (e.g., climbed/hiked 50 feet during a workout).

With continued reference to FIG. 5, the method 200 continues with a step of associating individual ones of a plurality of media items with at least one of (i) a particular time during the workout, and (ii) a particular position of the first user during the workout (block 220). Particularly, the processor 37 is configured to retrieve a plurality of media items from the memory 38 and display the plurality of media items on the display screen 34 to enable to user to select individual ones of plurality of media items to be shared with the workout. In response to the inputs from the user, the processor 37 is configured to associate the selected individual ones of the plurality of media items with a particular time during the workout and/or a particular position of the user during the workout.

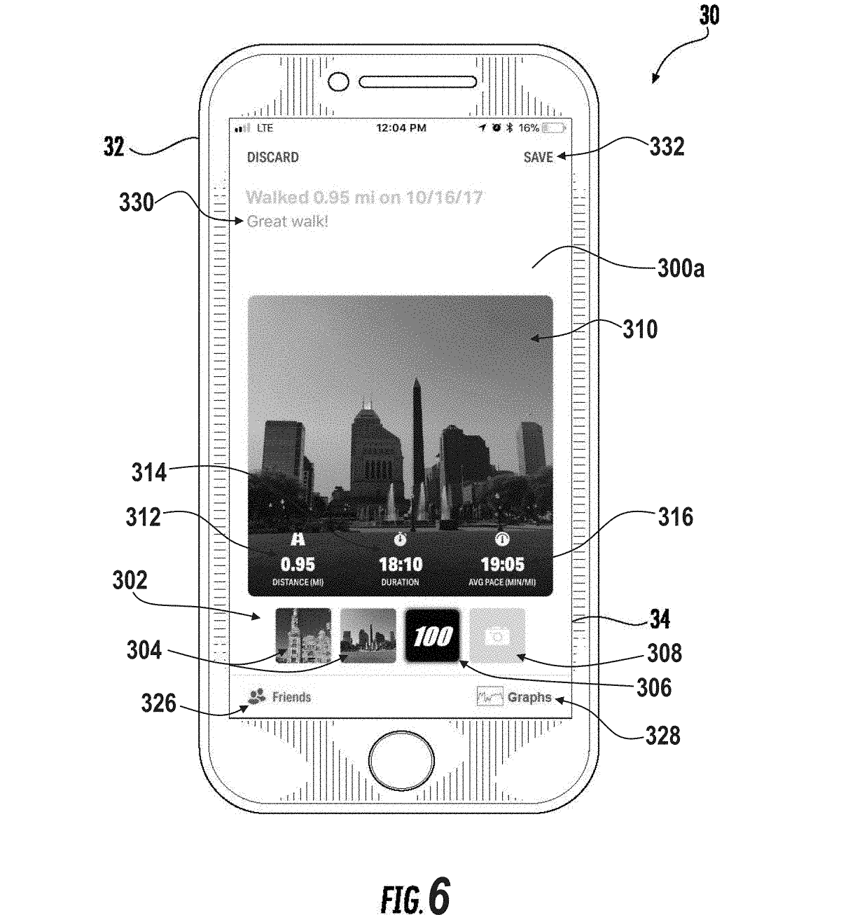

FIG. 6 shows an exemplary embodiment of a workout sharing screen 300a that is displayed on the display screen 34 of the electronic display device 30 to enable the user to select individual ones of a plurality of media items to be shared with the workout. Particularly, after the user has ended the tracking of the workout, the processor 37 executes instructions of the activity tracking application stored in the memory 38 to display the workout sharing screen 300a on the display screen 34. The workout sharing screen 300a at least includes a plurality of media items 302. The processor 37 is configured to automatically populate the plurality of media items 302 with photos and/or videos 304 that were captured using the activity tracking application during the workout, as described above with respect to the camera option 126 of the real-time tracking screen 100b shown in FIG. 4. Furthermore, the processor 37 is configured populate the plurality of media items 302 with icons 306 retrieved from the memory 38 corresponding to milestones or achievements that were satisfied during the workout (e.g., a “100” icon/badge for reaching 100 cumulative miles walked/ran). In at least one embodiment, the workout sharing screen 300a further includes an add photo option 308 via which the user may capture a new post-workout photo and/or video, as well as add photos and/or videos that were captured outside of the activity tracking application, such as with a native camera application of an operating system of the electronic display device 30.

The workout sharing screen 300a enables the user to select individual ones of the plurality of media items 302 to be shared in association with the workout. Particularly, the processor 37 is configured to receive inputs from the user, such as taps or swipes on the display screen, indicating which of the plurality of media items 302 should be shared with the workout. The processor 37 is configured to associate the selected individual ones of the plurality of media items 302 with a particular time during the workout and/or a particular position of the user during the workout. In the case of the photos and/or videos 304, the processor 37 is configured to read a timestamp of the respective photo and/or video 304 indicating a time at which the photo and/or video 304 was captured. The processor 37 is configured to associate the photo and/or video 304 with a particular time during the workout corresponding to the timestamp and/or to associate the photo and/or video 304 with the position of the user at that particular time during the workout. In the case of the icon 306, the processor is configured to associate the icon 306 with a particular time during the workout corresponding to when the respective performance criterion was satisfied and/or to associate the icon 306 with the position of the user at that particular time during the workout.

In at least one embodiment, the workout sharing screen 300a further enables the user to select one of the plurality of media items 302 to be a highlight photo for the workout. Particularly, in response to inputs from the user, the processor 37 is configured to display a highlight photo preview 310 corresponding to a selected first media item of the plurality of media items 302. The highlight photo preview 310 comprises the selected one of the plurality of media items 302. In at least one embodiment, the highlight photo preview 310 includes one or more performance metrics overlaid thereon. Particularly, in the embodiment shown, the highlight photo preview 310 includes three performance metrics 312, 314, and 316 overlaid thereon, each performance metric having a value and a corresponding labels (e.g., a “0.95” value for the “DISTANCE (MI)” performance metric, a “18:10” value for the “DURATION” performance metric, and a “19:05” value for the “AVG PACE (MIN/MI)” performance metric). In one embodiment, in response to the user pressing the highlight photo preview 310 or pressing some other option on the workout sharing screen 300a, the processor 37 is configured to provide further options for customizing which performance metrics are overlaid onto the highlight photo.

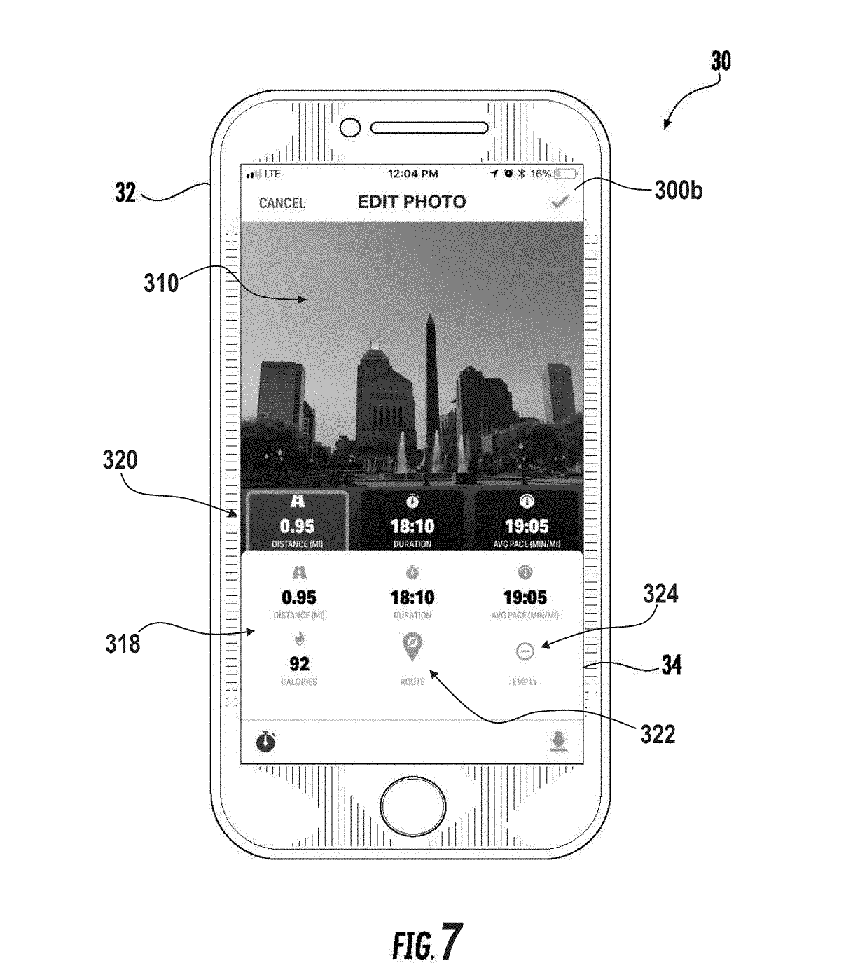

FIG. 7 shows an exemplary embodiment of a highlight photo screen 300b that is displayed on the display screen 34 of the electronic display device 30 to enable the user to select individual ones of a plurality of performance metrics to be overlaid on the highlight photo for the workout. The highlight photo screen 300b at least includes a plurality of performance metric options 318. The plurality of performance metric options 318 includes at least one option that is different from the three default performance metrics that are overlaid on the highlight photo 310 (e.g., a “92” value for the “CALORIES” performance metric). The user may select one of the performance metric slots 320 and then press one of the performance metric options 324 to swap which performance metric is overlaid onto the highlight photo 310. In response to a user pressing one of the performance metric options 318, the processor 37 is configured to overlay the performance metric on the highlight photo 310 in the selected slot 320. In one embodiment, the plurality of performance metric options 318 includes a route thumbnail option 322, which when pressed overlays a thumbnail of a route of the workout at the selected slot 320. In one embodiment, the plurality of performance metric options 318 includes an empty slot option 324, which when pressed removes any overlaid performance metric at the selected slot 320, thereby reducing a total number of overlaid performance metrics.

Returning to FIG. 6, some embodiments, the workout sharing screen 300a further includes a privacy option 326, which when pressed, provides an additional menu via which the user can select a privacy setting for the shared workout. Particularly, in one embodiment, the user may select between a “Public” option in which the anyone can see the shared workout, a “Friends” option in which only friends can see the shared workout, and “Me” option in which only the user can see the shared workout. In some embodiments, the workout sharing screen 300a further includes a graphs option 328, which when pressed, provides an additional menu via which the user can select a performance metric to be shared with the workout as a data plot showing a plurality of values of the performance metric as a function of time for the duration of the workout. Some exemplary options for display as a data plot include elevation, heart rate, and speed. In some embodiments, the workout sharing screen 300a further includes a text box 330 via which the user can enter text to share with the workout (e.g., “Great walk!”).

With reference again to FIG. 5, after associating individual ones of a plurality of media items with at least one of (i) a particular time during the workout, and (ii) a particular position of the first user during the workout, the method 200 continues with a step of uploading workout data to a remote server (block 230). The workout data at least includes the plurality of performance metrics of the first user for the duration of the workout, the individual ones of plurality of media items, and the associations between each of the individual ones of plurality of media items and the at least one of (i) the particular time during the workout and (ii) the particular position of the first user during the workout (block 230). Particularly, after the user has finished preparing and customizing the data to be shared with the workout as discussed above, the processor 37 is configured to upload the workout data to a remote server. The workout data at least includes the plurality of performance metrics for the workout, the individual ones of the plurality of media items that were selected to be shared, and the associations between the individual media items and the time and/or position of the user during the workout. In some embodiments, the workout data further includes one or more customization flags/options regarding which media item is to be displayed as the highlight photo, which performance metrics are to be overlaid on the highlight photo, which performance metric is to be displayed as a data plot, any text to be shared with the workout, and the selected privacy settings for the workout. In one embodiment, the processor 37 is configured to upload the workout data in response to the user pressing a save option 332 of the workout sharing screen 300a. Once the workout data is uploaded the remote server, other users can download the workout data and the workout data is presented to the other users on their respective electronic display device 30, as discussed in greater detail below.

In some embodiments, the workout data, which includes the plurality of performance metrics for the workout, the individual ones of the plurality of media items that were selected to be shared, and the associations between the individual media items and the time and/or position of the user during the workout, is also uploaded and/or shared with a third-party server, such as that of a social networking platform (e.g., Facebook, Twitter, Instagram, etc.). In some embodiments, the workout data may also be transmitted and/or shared with other users via email or text messaging services. In some embodiments, prior to uploading the workout data, the processor 37 is configured to compile the workout data into a preferable and/or required format for the respective platform via which the workout data is shared. In one embodiment, the processor 37 is configured to upload the workout data utilizing a corresponding API (application programming interface) for the respective platform via which the workout data is shared.

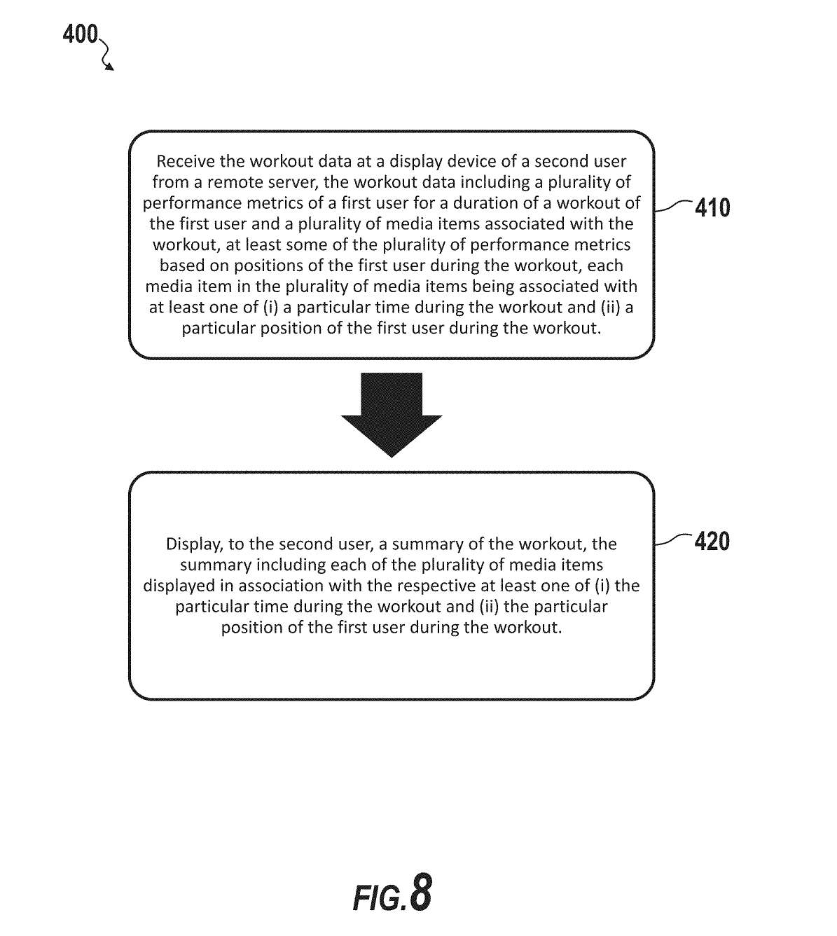

FIG. 8 shows a logical flow diagram for a method 400 of presenting workout data to a user of a fitness tracking system. The method 400 begins with a step of receiving the workout data at a display device of a second user from a remote server (block 410). As similarly discussed with respect to the method 200, the workout data includes a plurality of performance metrics of a first user for a duration of a workout of the first user and a plurality of media items associated with the workout (block 410). At least some of the plurality of performance metrics are based on positions of the first user during the workout and each media item in the plurality of media items is associated with at least one of (i) a particular time during the workout and (ii) a particular position of the first user during the workout (block 410). Particularly, with respect to the embodiments described in detail herein, the processor 37 of the electronic display device 30 is configured to download the workout data discussed above from the remote server. In some embodiments, the processor 37 is configured to download a multitude of various shared contents for display in a list on the display screen 34 as a news feed. The various shared contents can include workout data shared by a many different users of the fitness tracking system 10, as well as fitness related articles curated by an administrator of the fitness tracking system 10, photos and/or videos shared by other users of the fitness tracking system 10, and text shared by other users of the fitness tracking system 10.

With continued reference to FIG. 8, the method 400 continues with a step of displaying, to the second user, a summary of the workout (block 420). The summary includes each of the plurality of media items displayed in association with the respective at least one of (i) the particular time during the workout and (ii) the particular position of the first user during the workout (block 420). Particularly, the processor 37 is configured to cause the display screen 34 to display a summary of the workout data received from the remote server. Particularly, the summary at least includes the plurality of media items presented in association with the particular time during the workout and/or the particular position of the user during the workout.

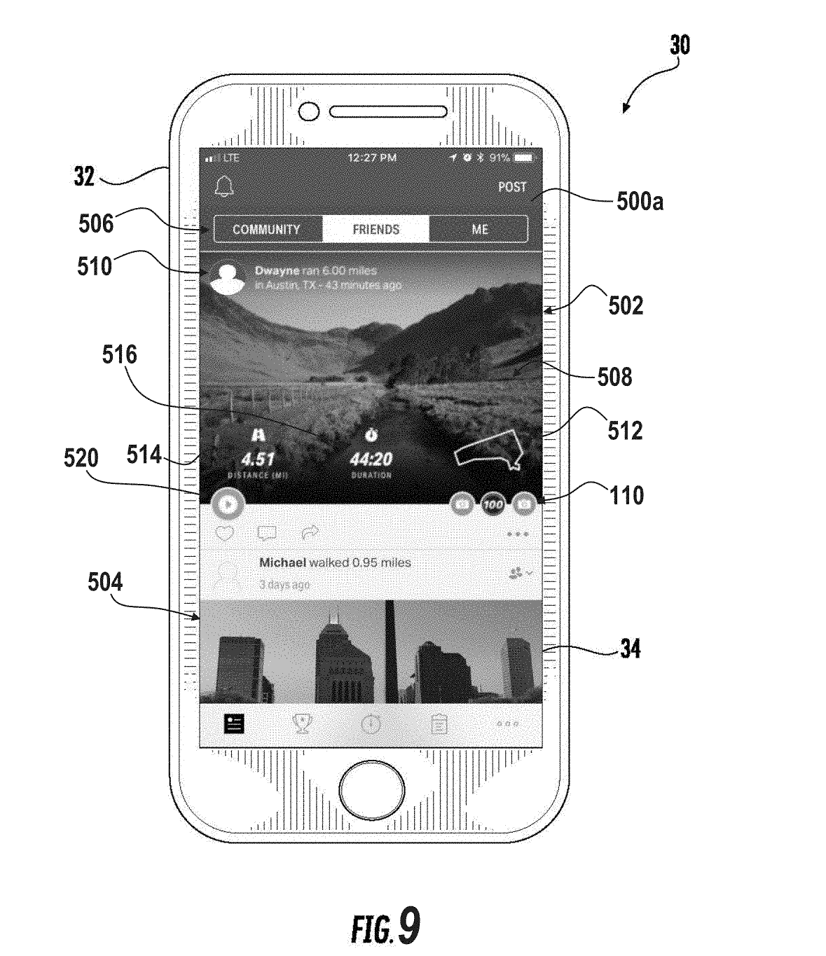

FIG. 9 shows an exemplary embodiment of an activity feed screen 500a that is displayed on the display screen 34 of the electronic display device 30 to enable users to view contents, including workout summaries, shared by friends and other members of the community. The activity feed screen 500a includes a list of multimedia content (which may also be referred to herein as a “feed”) shared by the user, friends of the user, and other members of the community. As shown, the feed includes a workout summary 502 shared by friend of the user (e.g., “Dwayne”), as well as a workout summary 504 shared by the user himself (e.g., “Michael”). The activity feed screen 500a further includes filter options 506 via which the user can sort which contents are included in the feed. For example, in the embodiment shown, the user may press a “Community” option to show all content shared by the user, friends of the user, and other members of the community. Similarly, the user may press the “Friends” option to show only content shared by the user and friends of the user. Finally, the user may press the “Me” option to show only content shared by the user.

In one embodiment, the workout summary 502 includes a highlight photo 508 which was selected by the other user after his workout in the manner described above with respect to the method 200. Identifying information 510 is overlaid upon the highlight photo 508 that describes the content (e.g., “Dwayne ran 6.00 miles in Austin, Tex.—43 minutes ago”). Similarly, a route 512 and performance metrics 514 and 516 are overlaid upon the highlight photo 508 (e.g., a “4.51” value for the “DISTANCE (MI)” performance metric and a “44:20” value for the “DURATION” performance metric). The route 512 and performance metrics 514 and 516 were selected by the other user after his workout in the manner described above with respect to the method 200.

The workout summary 502 includes icons 518 that correspond to a plurality of media items that were shared with the workout. The plurality of media items were selected by the other user after his workout in the manner described above with respect to the method 200. In the embodiment shown, the icons 518 include two photo icons (e.g., a camera icon or thumbnail) indicating that two photos are shared with the workout and a badge icon (e.g., a “100” cumulative miles walked/ran badge) indicating that an achievement or milestone is shared with the workout.

If a user would like view a more detailed workout summary, the user may press the highlight photo 508, as discussed in further detail below. Additionally, in some embodiments, the user may press one the icons 518 to show the corresponding media item. In one embodiment, the user may press a play option 520 to show an animation or automated presentation for the shared workout, discussed in further detail below.

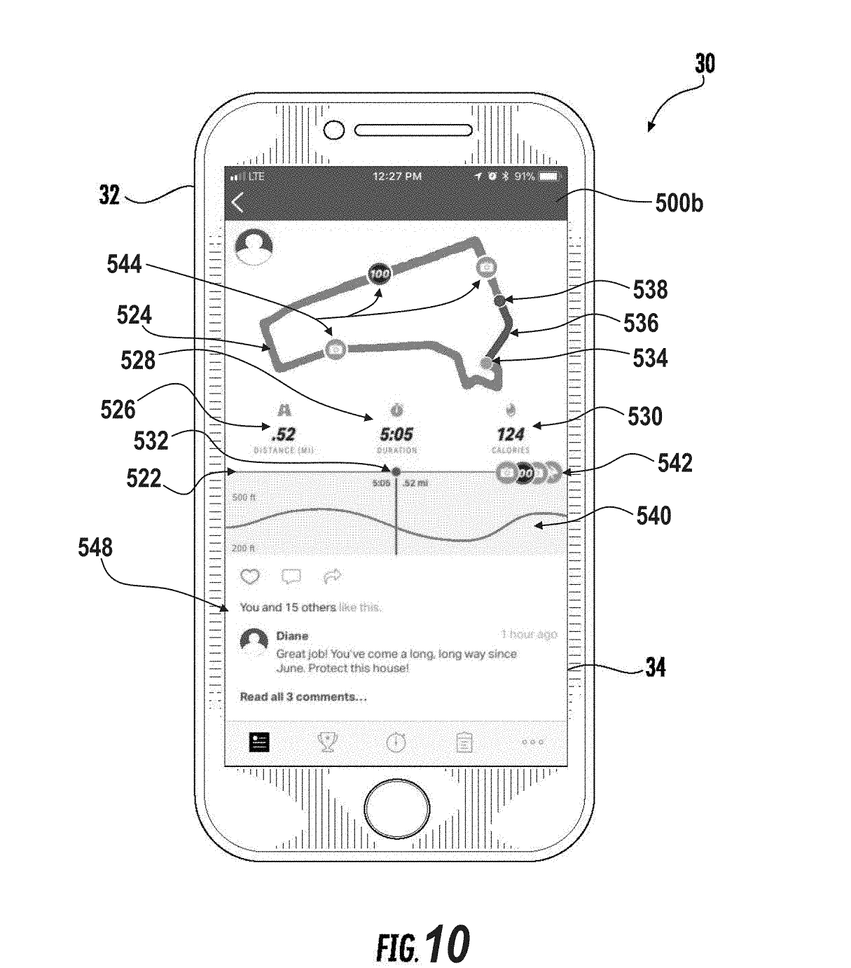

FIG. 10 shows an exemplary embodiment of a workout summary screen 500b that is displayed on the display screen 34 of the electronic display device 30 to enable users to view a detailed summary of a user's workout. Particularly, in response to the user pressing the highlight photo 508 or the play option 520, the processor 37 is configured to cause the display screen 34 to display the detailed workout summary screen 500b. The detailed workout summary screen 500b at least includes a presentation of each of the media items in association with the particular time during the workout and/or the particular position of the user during the workout.

In the embodiment shown, the workout summary screen 500b includes a timeline 522, a route 524, and performance metrics 526, 528, and 530 that illustrate the workout shared by the other user. The timeline 522 includes a time indicator 532 that indicates a selected time of the workout (e.g., “5:05”) and, optionally, cumulative distance of the workout at the selected time (e.g. “0.52 mi”). The route 524 has, overlaid thereon, a starting location indicator 534 indicating a location that the user started the workout, a traveled path indicator 536 indicating a path traveled by the user thus far at the selected time during the workout, and a current location indicator 538 indicating a location of the user at the selected time of the workout. In one embodiment, the route 524 is overlaid upon a map of a surrounding area (not shown). In one embodiment, the route 524 is omitted and the indicators 534, 536, and 538 are simply overlaid upon the map. The performance metrics 526, 528, and 530 show current values for various performance metrics at the selected time of the workout (e.g., a “0.52” value for the “DISTANCE (MI)” performance metric, a “5:05” value for the “DURATION” performance metric, and a “124” value for the “CALORIES” performance metric). The particular performances metrics shown on the workout summary screen 500b may be the same or different than the performance metrics overlaid on the highlight photo 508. In at least one embodiment, the particular performance metrics shown in the workout summary screen 500b were selected by the other user after his workout, in a manner similar to that which was described above with respect to the method 200.

In one embodiment, in response to the user pressing the play option 520 of the activity feed screen 500a, the processor 37 is configured to animate the time indicator 532, the path indicator 536, the current location indicator 538, and the values of the performance metrics 526, 528, and 530 such that they show the progress of the workout over a period of time. Particularly, during the animation, the value of the time indicator 532 progresses from zero to a time corresponding to the total duration of the workout. In some embodiments, the time indicator 532 may also move along the timeline 522 as the animation progresses. Similarly, during the animation, the values of the performance metrics 526, 528, and 530 progress from starting values to ending/total values for the workout. Finally, during the animation, the current location indicator 538 moves along the route 524 from the starting location to the ending location for the workout. In at least one embodiment, the animation is performed at an accelerated speed compared to the actual time of the workout.

In one embodiment, the user can press the timeline 522 and/or the route 524 to select different particular times and positions of the workout. In response to the user selecting a time or position of the workout, the time indicator 532 is updated and/or repositioned on the timeline and the current location indicator 538 is updated and/or repositioned on the route 524. Additionally, the values of the performance metrics 526, 528, and 530 are updated to reflect the selected time and position of the workout.

In one embodiment, the workout summary screen 500b further includes a data plot 540 for a performance metric (e.g. elevation or heart rate) showing a plurality of values of the performance metric as a function of time for the duration of the workout. The particular performance metric shown in the data plot 540 was selected by the other user after his workout in the matter described above with respect to the method 200.

The workout summary screen 500b includes a plurality of icons 542 and 544 that correspond to media items shared with the workout, which are similar to the icons 518 of the activity feed screen 500a. Particularly in the embodiment shown, the icons 542 and 544 include photo icons (e.g., a camera icon or thumbnail) corresponding to photos that are associated with the workout and badge icons (e.g., a “100” cumulative miles walked/ran badge) corresponding to achievements or milestones that are associated with the workout. The icons 542 are overlaid on the timeline 522 based on the time associated with media item to which the respective icon 542 corresponds. Similarly, the icons 544 are overlaid on the route 524 based on the position associated with media item to which the respective icon 544 corresponds.

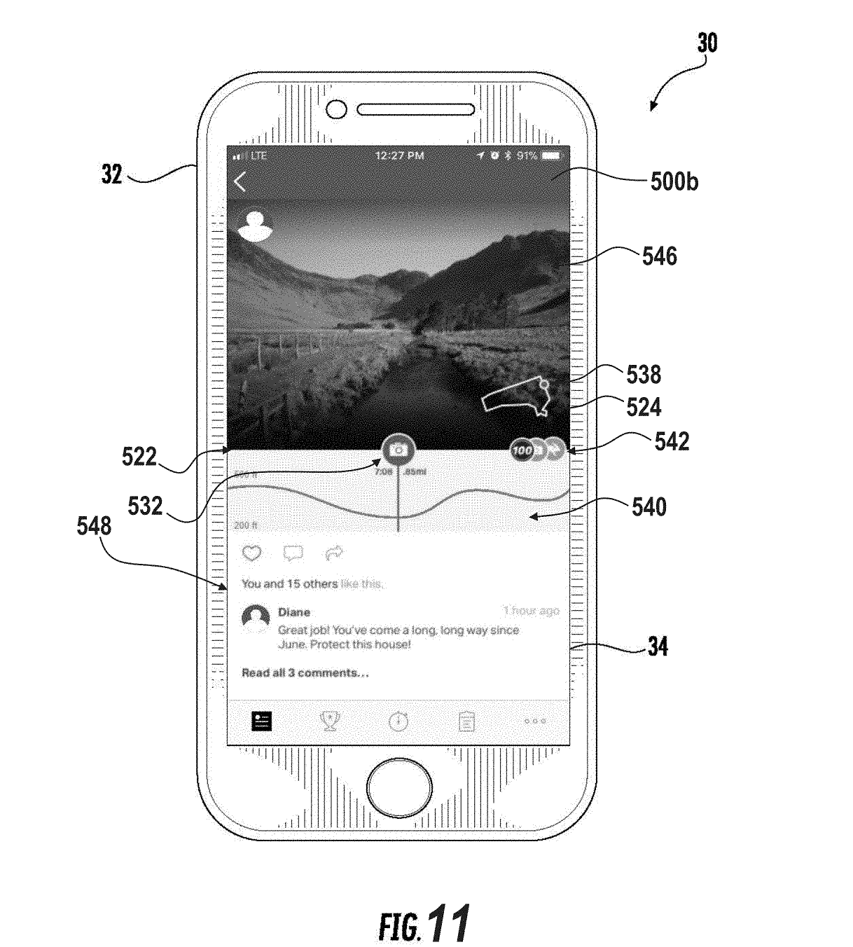

FIG. 11 shows an exemplary embodiment of a media item screen 500c that is displayed on the display screen 34 of the electronic display device 30 to enable users to view a media item that was shared with a workout. The media item screen 500c is similar to the workout summary screen 500b, except that the route 524 and performance metrics 526, 528, and 530 are hidden and a respective media item 546 is displayed prominently in the media item screen 500c. In one embodiment the smaller thumbnail of the route 524 and current location indicator 538 are overlaid on the media item 546. As discussed elsewhere, the media item 546 may comprise a photo and/or video that was taken at a particular time during the workout. Additionally, the media item 546 may comprise predetermined graphic corresponding to a particular achievement or milestone that was achieved at the particular time during the workout.

In some embodiments, during the animation of the workout discussed above, the processor 37 is configured to automatically display the media item screen 500c with a corresponding media item at the particular times and/or positions associated with each media item. After a predetermined amount of time has passed (e.g., 15 seconds or duration of video if the media item is a video), the processor 37 is configured to cause the display screen 34 to return to the workout summary screen 500b. Additionally, in some embodiments, the processor 37 is also configured to display the media item screen 500c with a respective media item in response to the user pressing the icons 518 of the activity feed screen 500a or the icons 540 or 542 of the workout summary screen 500b.

In some embodiments, the workout summary screen 500b and the media item screen 500c includes a comment section 548 via which the user can share comments about the workout, view comments from other users (e.g., “Great Job! You've come a long, long way since June. Protect this house!”), or indicate that he or she likes the shared workout.

Returning to FIG. 9, in some embodiments, the feed may include grouped workout summaries for groups of multiple users. For example, if a group of users have worked out together and each user tracked his or her workout, the users' respective workout summaries may be grouped together. In such cases, the processor 37 is configured to display screens similar to the workout summary screen 500b and the media item screen 500c, but which include multiple timelines, routes, and/or values of performance metrics corresponding multiple users, as well as media items that were shared by each user in the group.

The above description of presenting workout data as an interactive workout summary is made within the context of the activity tracking application which is also used to record the workout data. However, as discussed above, in some embodiments the workout data, which includes the plurality of performance metrics for the workout, the individual ones of the plurality of media items that were selected to be shared, and the associations between the individual media items and the time and/or position of the user during the workout, is also uploaded and/or shared with a third-party server, such as that of a social networking platform (e.g., Facebook, Twitter, Instagram, etc.). Additionally, in some embodiments, the workout data may also be transmitted and/or shared with other users via email or text messaging services. In this way, the workout data may be presented to other users on these third-party platforms as an interactive workout summary in a manner analogous to the methods discussed above. In some embodiments, the processor 37 is configured to generate program instruction, scripts, or the like, which are compatible with the respective third-party platform and configured for presenting the workout data in the manner discussed above.

The herein described applications (e.g., the activity tracking application) improve the functioning of the electronic display device 30 and/or activity tracking devices 20, respectively or in combination by enabling it/them to improve user engagement and performance, and even improve adherence to health and fitness programs. Particularly, by associating media items with a workout, the user is able to better recall specific details of the workout which may otherwise be forgotten. The user may then be able to glean information about the workout and ideas for improved performance from such details. For example, if a user takes a photo of a particular venue (e.g., park, landscape, building, monument, etc.) during a workout, and later recognizes that his or her pace or other performance parameter is improved near this venue, the user may wish to perform additional workouts that pass by the venue, knowing that this venue is particularly inspiring to the user. In this manner, devices that are able to provide additional workout data and assemble stories related to the workout can operate more efficiently to improve health and fitness outcomes.

Prior art devices have been incapable of track performance metrics of an athlete or other user for a duration of a workout and associating media items with at least one of (i) a particular time during the workout, and/or (ii) a particular position of the user during the workout. By allowing the user to capture media items during the workout and associate such media items with particular positions or times during the workout, the user is provided with valuable data logging tool that may be used to improve performance and fitness outcomes in general. The user interface that displays a workout summary including media items shown in association with particular times and positions during the workout may be used by the athlete to not only recall the details of a workout, but also better plan strategies for future workouts. Instead of merely displaying raw numbers associated with a specific workout (e.g., distance, time, average pace, heart rate, etc.), the improved health monitoring system described herein provides the user with valuable workout data that is uniquely provided via the improved display (e.g., visual images seen by the user, feelings of the user as captured in photographs, or even the specific weather conditions at a particular location along a route). In this manner, rather than immediately losing valuable workout details (e.g., environmental conditions, feeling, community, etc.), an athlete or other user is provided with a display that will effectively capture this information and make it available for future review and analysis. With this tool in hand, athletes may learn to enjoy the workout even more as they creatively capture a more complete story of their workout than would be available with numbers alone, the more complete story being provided in party by one or more photos or other images. When these images are associated with various times and positions of the user during the workout, as described herein, the user has a personalized account of workout details that present a more complete workout story to the user, which details may be best interpreted and analyzed by the user.

In addition to the value of the health tracking system to the individual user, the herein described applications enable users to better visualize and experience a workout that has been shared by another user. Particularly, merely sharing statistics such as distance, pace, and time for a workout, such as a run, does not always fully convey the experience of a workout to other users. However, by associating media items, such as photos or videos, with particular times or positions during the workout, another user is better able to imagine what it felt like to experience the workout.

In at least one embodiment, portions of the system and methods described herein may be implemented in suitable software code that may reside within the memory. Such software code may be present on the device 30 at the time of manufacture or may be downloaded thereto via well-known mechanisms. A computer program product implementing an embodiment disclosed herein may therefore comprise one or more computer-readable storage media storing computer instructions translatable by a processor to provide an embodiment of a system or perform an embodiment of a method disclosed herein. Computer instructions may be provided by lines of code in any of various languages as will be recognized by those of ordinary skill in the art. A “computer-readable medium” may be any type of data storage medium that can store computer instructions, including, but not limited to the memory devices discussed above.

In another embodiment, a permanent copy of the programming instructions for individual ones of the aforementioned applications (e.g., the activity tracking application) may be placed into permanent storage devices (such as e.g., memory 28 and/or memory 38) during manufacture thereof, or in the field, through e.g., a distribution medium (not shown), such as a compact disc (CD), or through transmitter/receiver 29 and/or transmitter/receiver 39 (from a distribution server (not shown)). That is, one or more distribution media having an implementation of the agent program may be employed to distribute the agent and program various computing devices.

The foregoing detailed description of one or more exemplary embodiments of the activity tracking application has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

It will be appreciated that the various ones of the foregoing aspects of the present disclosure, or any parts or functions thereof, may be implemented using hardware, software, firmware, tangible, and non-transitory computer readable or computer usable storage media having instructions stored thereon, or a combination thereof, and may be implemented in one or more computer systems.

What is claimed is:

1. A method of operating a health tracking system, the method comprising:
tracking a plurality of performance metrics of a user for a duration of a workout of the user using at least one sensor of the health tracking system, at least some of the plurality of performance metrics based on positions of the user during the workout, the positions of the user during the workout being sensed using a position sensor of the health tracking system;
associating individual ones of a plurality of media items with at least one of (i) a particular time during the workout, and (ii) a particular position of the user during the workout; and
displaying a summary of the workout on a display device of the health tracking system, the summary including the individual ones of the plurality of media items displayed in association with its respective at least one of (i) the particular time during the workout, and (ii) the particular position of the user during the workout.

2. The method according to claim 1 further comprising:
receiving inputs from the user that indicate which of the plurality of media items which shall comprise the individual ones of the plurality of media items.

3. The method according to claim 1, wherein at least one of the individual ones of the plurality of media items comprises an image and/or a video, and the act of associating the image and/or the video with at least one of (i) a particular time during the workout at which the image and/or the video was captured and (ii) a particular position of the user during the workout at which the image and/or the video was captured, is based on a timestamp of the image and/or the video.

4. The method according to claim 1 further comprising:
comparing at least one performance metric in the plurality of performance metrics with a predetermined performance criterion for the at least one performance metric;
retrieving, as one of the individual ones of the plurality of media items, an icon corresponding to the predetermined performance criterion, in response to the at least one performance metric satisfying the predetermined performance criterion; and
associating the icon with at least one of (i) a particular time during the workout at which the predetermined performance criterion was satisfied and (ii) a particular position of the user during the workout at which the predetermined performance criterion was satisfied.

5. The method according to claim 1, wherein the act of displaying the summary further comprises:
displaying a timeline of the workout, wherein visual representations of the individual ones of the plurality of media items are overlaid on the timeline at the respective times during the workout with which the respective individual ones of the plurality of media items are associated.

6. The method according to claim 5, wherein the act of displaying the summary further comprises:
displaying a data plot of at least one performance metric in the plurality of performance metrics, the data plot being one of (i) arranged adjacent to and (ii) overlaid upon the timeline of the workout.

7. The method according to claim 6 further comprising:
prior to displaying the data plot, receiving inputs from the user indicating a selection of the at least one performance metric to be displayed in the data plot.

8. The method according to claim 1, wherein the act of displaying the summary further comprises:
determining a route of the workout based on the positions of the user during the workout; and
displaying the route of the workout, wherein visual representations of the individual ones of the plurality of media items are overlaid on the route at the respective positions of the user during the workout with which the respective individual ones of the plurality of media items are associated.

9. The method according to claim 1, wherein the act of displaying the summary further comprises:
receiving an input via the display device; and
displaying, in response to the input, the individual ones of the plurality of media items sequentially in chronological order based on the times during the workout associated therewith.

10. The method according to claim 1 further comprising:
receiving inputs from the user indicating a selection of a first media item of the individual ones of the plurality of media items;
displaying the first media item on the display device, at least one performance metric in the plurality of performance metrics being overlaid upon first media item; and
displaying the summary of the workout concurrently with and/or after displaying first media item.

11. The method according to claim 10 further comprising:
displaying a list of media items on the display device, the first media item being one of the media items in the list of media items;
receiving inputs indicating a selection of the first media item from the list of media items; and
displaying the summary of the workout in response to receiving the selection of the first media item.

12. The method according to claim 10 further comprising:
prior to displaying the first media item, receiving inputs from the user indicating a selection of the at least one performance metric to be overlaid upon the first media item.

13. A method of operating a health tracking system, the method comprising:
receiving workout data at a display device of a first user of the health tracking system from a remote server of the health tracking system, the workout data including a plurality of performance metrics of a second user for a duration of a workout of the second user and a plurality of media items associated with the workout, at least some of the plurality of performance metrics based on positions of the second user during the workout, each media item in the plurality of media items being associated with (i) a particular time during the workout and (ii) a particular position of the second user during the workout; and
displaying a timeline of the workout on the display device of the first user, wherein visual representations of the media items in the plurality of media items are overlaid on the timeline at the respective times during the workout with which the respective media items are associated.

14. The method according to claim 13, wherein the act of displaying the timeline further comprises:
displaying a data plot of at least one performance metric in the plurality of performance metrics of the second user, the data plot being one of (i) arranged adjacent to and (ii) overlaid upon the timeline of the workout.

15. The method according to claim 13, wherein the act of displaying the timeline further comprises:
displaying a route of the workout that is based on the positions of the second user during the workout, a visual representation of each media item in the plurality of media items being overlaid on the route at the respective position of the second user during the workout with which the respective media item is associated.

16. The method according to claim 13, wherein the act of displaying the timeline further comprises:
displaying a plurality of individual timelines of workouts associated to various ones of a plurality of users which the first user has selected.

17. The method according to claim 13 further comprising:
displaying a first media item in the plurality of media items on the display device of the first user, at least one performance metric in the plurality of performance metrics being overlaid upon first media item in the plurality of media items; and
displaying the timeline of the workout concurrently with and/or after displaying first media item in the plurality of media items.

18. A health tracking system comprising:
a first mobile display device having at least a camera and a position sensor, the first mobile display device configured to:
capture a plurality of media items using the camera;
track a plurality of performance metrics of a first user for a duration of a workout of the first user, at least some of the plurality of performance metrics based on positions of the first user during the workout, the positions of the user sensed using the position sensor; and
associate individual ones of the plurality of media items with at least one of (i) a particular time during the workout and (ii) a particular position of the first user during the workout.

19. The health tracking system of claim 18 further comprising:
a remote server in communication with the first mobile display device and configured to receive workout data from the first mobile display device, the workout data including the plurality of the performance metrics of the first user for the duration of the workout, the individual ones of plurality of media items, and the associations of each of the individual ones of plurality of media items with the respective at least one of (i) the particular time during the workout and (ii) the particular position of the first user during the workout.

20. The health tracking system of claim 19 further comprising:
a second mobile display device in communication with the remote server, the second mobile display device configured to:
receive the workout data from the remote server; and
display, to a second user, a summary of the workout, the summary including each of the individual ones of plurality of media items displayed in association with the respective at least one of (i) the particular time during the workout and (ii) the particular position of the first user during the workout.
